(19) United States
(12) Patent Application Publication
(10) Pub. No.: US 2012/0188345 A1
(43) Pub. Date: Jul. 26, 2012

(54) APPARATUS AND METHOD FOR STREAMING LIVE IMAGES, AUDIO AND META-DATA

(75) Inventor: Christopher A. Salow, Stockbridge, MI (US)

(73) Assignee: PAIRASIGHT, INC., Pleasant Lake, MI (US)

(21) Appl. No.: 13/358,118

(22) Filed: Jan. 25, 2012

Related U.S. Application Data
(60) Provisional application No. 61/435,902, filed on Jan. 25, 2011.

(51) Int. Cl. H04N 13/02; H04N 7/18

(52) U.S. Cl. 348/47; 348/143; 348/E13.074; 348/E13.014; 348/E07.085

(57) ABSTRACT

A method for streaming and viewing a user's video and audio experiences includes removably mounting an image recording device in close proximity to a user's eyes such that the image recording device is operable to record the user's visual and audio experiences. A real time signal is created by the image recording device, including at least one of video footage, still images, or audio captured by the image recording device. The real time signal is streamed from the image recording device to a server using at least one communications network. The real time signal is transmitted from the server to a remote communication device for producing an output that is perceptible to a viewer so that said viewer can experience the user's environment and the user's relationship to the environment.

### CROSS-REFERENCE TO RELATED APPLICATION

This application claims the benefit of U.S. Provisional Patent Application Ser. No. 61/435,902, filed on Jan. 25, 2011.

### FIELD OF THE INVENTION

The present invention relates to an apparatus and method for streaming live video footage, still images, audio, date, time, and sensor data (“meta-data”), and more particularly, the present invention relates to an image recording device integrally mounted on or around a user's eyes, such as on a pair of eyeglasses, wherein the images transmitted on the image recording device may be recorded and/or streamed live onto one or more web servers on the internet and/or a communication device, such as a smart phone, so as to transmit information about the user's environment and their relationships to the environment through the user's visual and audio experiences to at least one viewer.

### BACKGROUND OF THE INVENTION

Digital video cameras and still cameras are well known. They allow people to capture video footage and images of their experiences while sharing such video footage and images with their friends and family at a later date and time. However, such devices do not allow the user of the video or still camera to experience the video footage or images with a third party while the video footage or images are being taken unless the third party is with the user during the taking of the video footage or still images. Thus, digital video and still cameras are limited in allowing a person to experience video footage and images with another person in real time.

Television provides a media wherein real time video and images can be streamed over a network so that viewers can watch video footage and images live or in real time. Broadcasting companies have also mounted video cameras to certain objects and people so that the viewer can have a sense of what the object or person wearing the camera is experiencing. For instance, athletes may wear a video camera to allow the viewer to experience what the athlete is experiencing in real time. However, such video clips are usually limited in length and are typically provided by custom cameras and mounts that are suited for the specific athlete or situation. Such custom cameras and mounts are expensive and custom to the wearer. In addition, the viewer does not have the ability to converse or communicate with the wearer of the camera while the video footage and images are being taken. This prohibits both the camera wearer and the viewer from sharing the experiences of the video footage and images with each other in real time.

Other methods of providing a viewer with more information regarding video footage and still images include geotagging which allows the date, time, and location of a photo or video clip to be embedded directly into the photo file. Although geotagging provides additional information to the viewer regarding the circumstances surrounding the video footage or still images, the information is embedded into the photo file and is not stored within a stream of data nor can it be controlled or manipulated in a stream of data.

It would be desirable to provide an apparatus and method for allowing any user to capture video footage and images in real time while allowing a third party to view such video footage and images and communicate with the user in real time.

### SUMMARY OF THE INVENTION

The present invention relates to a method for streaming and viewing a viewer's video and audio experiences. These experiences can include live video footage, still images, audio, and/or meta-data. An image recording device is removeably mounted in close proximity to a user's eyes such that the image recording device replicates and/or records the user's visual and audio experiences. A real time signal is created by the image recording device. The real time signal can include the video footage, still images, and/or audio captured by the image recording device. The real time signal is streamed from the image recording device to a server using at least one communications network, which can include the internet. The real time signal is transmitted from the server to a remote communication device for producing an output that is perceptible to at least one viewer. The at least one viewer can view and/or hear the real time signal so that the at least one viewer can experience the user's relationship to the environment.

### BRIEF DESCRIPTION OF THE DRAWINGS

The description herein makes reference to the accompanying drawings wherein like referenced numerals refer to like parts throughout several views and wherein:

FIG. 1 is a perspective view of a pair of eyeglasses having a camera mounted thereon according to the present invention;

FIG. 2 is a flow chart showing a method of the present invention;

FIG. 3 is a block diagram of electronic connections to the microprocessor used in the present invention;

FIG. 4 is a block diagram showing an example of an environment for implementation of a system for streaming and viewing a user's visual and audio experiences;

FIG. 5 is a block diagram showing an example of an environment for implementation of a system for streaming and viewing a user's visual and audio experiences; and

FIG. 6 is a block diagram showing an example of a computing device.

### DETAILED DESCRIPTION OF THE PREFERRED EMBODIMENT

Referring to the drawings, the present invention will now be described in detail with reference to the disclosed embodiment.

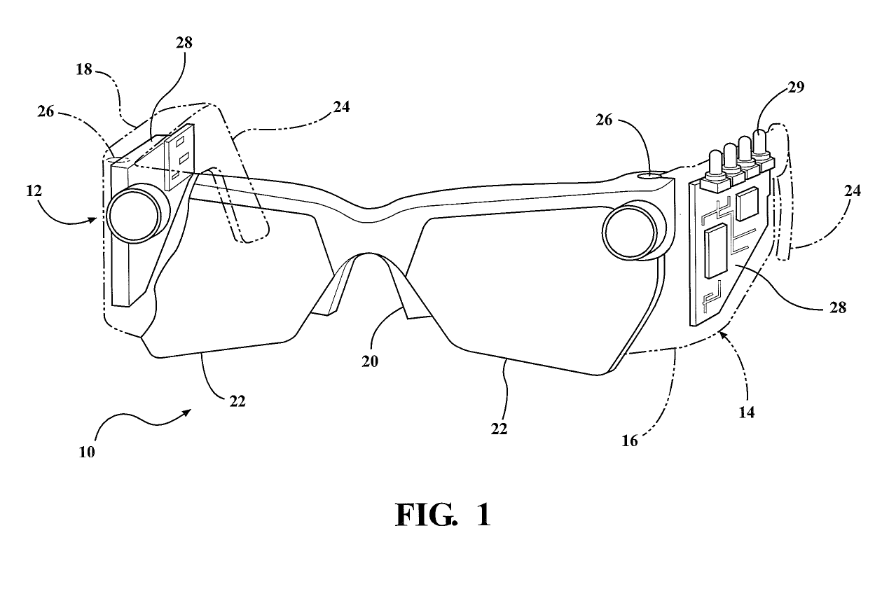

The present invention relates to an apparatus and method for streaming live video footage, still images, audio, date, time and sensor data (wherein data, time, and sensor data are referred to as “metadata”) of a user's visual and audio experiences, as shown in FIGS. 1-3. In order to capture the video footage, still images, audio, and metadata, the present invention provides an image recording device 10. The image recording device 10 includes at least one image sensor 12, which can be a digital image sensor that is operable record still images or videos. The image sensor 12 can be a portion of a digital video camera or a still digital camera that is incorporated in the image recording device 10. The image sensor 12 is connected to a mounting structure 14, such as a pair of eyeglasses 16, goggles, face mask, helmet, etc., that can be releasably mounted in close proximity to the eyes of a user (not shown).

By mounting the image recording device 10 close to the user's eyes, the user's visual and audio experiences can be captured by the image recording device 10. Once the image recording device 10 begins to transmit and/or record video footage, still images, audio sounds, and/or meta-data, the transmission is converted into a data stream that may be sent as a real time electronic signal, or the transmission may be recorded by the image recording device 10 and sent as an electronic signal at a later time. If the transmission is sent immediately, the data stream may be streamed as a live or real time electronic signal to a first communication device. The first communication device can be a local communication device (i.e., located in the proximity of the image recording device 10). As one example, the first communication device can be an integral part of the image recording device 10. As another example, the first communication device can be a personal communication device, such as a smart phone, tablet, computer, etc. that receives the transmission from the image recording device and relays the transmission. In one example, the first communication device may include a multi-core processor that is incorporated in the image recording device 10, and allows the processor to stream the real time signal directly to a web server using, for example, a cellular data modem.

The first communication device may receive and send the data stream to at least one web server using at least one communication network, such as the internet. The webserver can include or communicate with a website that allows viewers to access and view the data stream. Once the data stream is received by the website, the images, sound, and/or metadata provided by the electronic signal may be viewed and heard on the website by viewers accessing the website through a second communication device (not shown), such as a computer and/or a smart phone thereby allowing the viewer of the website to experience the user's environment and their relationship with the environment. A content distribution network may be utilized in the web server to handle real-time transcoding of the video stream to match the viewer's viewing capabilities. The viewers may utilize the second communication device to communicate with the user while the image recording device 10 is transmitting a live stream of video footage, still images, audio, and meta-data. Thus, the present invention allows the viewers to experience the user's visual and audio experiences in real time while also allowing the viewers to communicate with the user in real time.

In order to secure the image recording device 10 to the user, the mounting structure 14 may take on the form of eyeglasses 16, as seen in FIG. 1. The eyeglasses 16 include a frame 18 that may be molded of conventional plastic or any other light weight, high strength material. The frame 18 includes a frame front 20 that surrounds and secures a pair of lenses 22 and a pair of similar frame temples 24 that extend from and are connected to the frame front 20 by a pair of hinges 26. The lenses 22 may be conventional sunglass lenses, or the lenses 22 may comprise LCD/LED screens to allow for the projection of images or text on the screens for the user to view. The frame temples 24 extend to the top and/or rear of the ears (not shown) of the user to secure the eyeglasses 16 to the user's head (not shown). The frame temples 24 are sufficiently wide that the image recording device 10 can be connected to an inside surface of the frame temples 24 between the user's head and the frame temples 24. The image recording device 10 may be secured within a protective casing or enclosure 28 which is attached to or integrally formed in the frame 18 (near positions 16, 18 or 26), or the image recording device 10 may be attached directly to the frame 18. One image recording device 10 may be mounted on either or both sides of the frame 18. As an alternative, by having two image recording devices 10 mounted to the frame 18 of the eyeglasses 16, a video signal having two distinct video sources may be created to provide either stereoscopic playback (3D) or panoramic viewing. If two image recording devices 10 are utilized, then the image recording devices 10 may be attached electronically, for example, through the use of electrical wires (not shown). The electrical wires may extend along or within the frame 18 of the eyeglasses 16. A lens of the image sensor 12 of each of the image recording devices 10 extends forward toward the lenses 22 of the eyeglasses 16 so that the image recording devices 10 can transmit what the user is viewing and hearing. A focusing device may be added to lenses to control the focus on both lenses at the same time via a hand-held device or device mounted on the frame 18 of the eyeglasses. The focusing device may be controlled by the user, may be controlled remotely by a technician, may be controlled using an algorithm, or in any other manner.

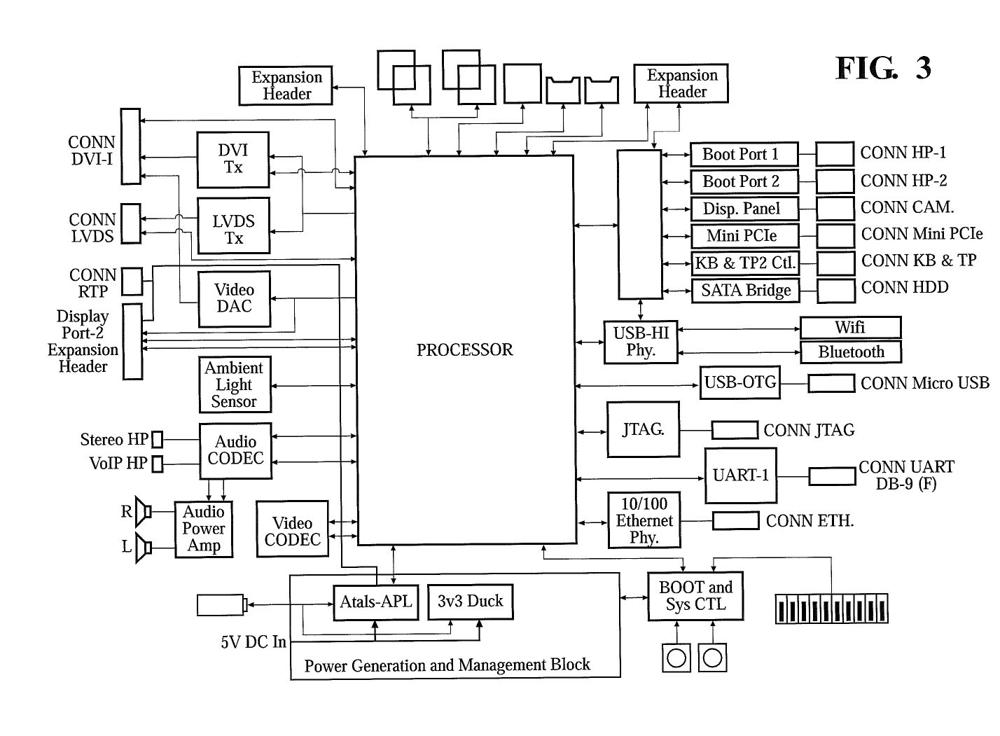

As previously noted, the image recording device 10 may include a digital video camera and/or a digital still camera with audio recording capability. The lens of the image recording device 10 projects an image to a digital image sensor (not shown) of the image recording device 10. The image recording device 10 further includes an image processor (not shown) that converts the signal from the image sensor to an electronic image signal, as will be further discussed later in the specification. The image processor is electrically connected to a controller or processor 30 of the image recording device 10, as seen in FIG. 3. The processor 30 is electrically connected to the controls of the image recording device 10, such as a power switch (not shown), status lights (not shown), internal hard drive (not shown), memory cards (not shown), flash memory (not shown),input/output interfaces 29, playback controls (not shown), zoom lens controls (not shown), etc. The processor 30 may provide feedback and status information to the user via LED lights or audible notifications. The processor 30 may also act as a standalone computer when not being utilized to control the image recording device 10. The standalone computer could utilize a shared internet connection from a smart phone or utilize a WiFi connection. The image recording device 10 may utilize the internal hard drive or memory cards for recording the images being transmitted, or the images recorded may be streamed directly to one or more web servers on the internet. By providing an internal hard drive or memory card, the user may record and review the images before sending the data stream to the internet, or the user may edit the images before sending the data stream to the internet. The input/output interfaces may allow for a USB port connection so that a computer can be connected directly to the image recording device 10 for reviewing, editing, and sending the image recording. The input/output interfaces may allow for other types of connectivity such as infrared, near field communications, acoustic data communications, as well as a type of brain control interface. In addition, the user may record an event, and then subsequently decide to send the recording to the internet. The image recording device 10 is powered by a conventional battery source.

The image recording device can also record and transmit metadata. As one example, the image recording device 10 can incorporate a geo location sensitive device such as, for example, a Global Positioning System receiver, which can output geo location metadata. Other types of metadata can be recorded and transmitted by the image recording device 10.

In order to create a data stream comprising the video and audio signals from the image recording device 10, the present invention provides a “Reduced Instruction Set Computer” central processing unit as well as at least one hardware based video and audio compressor to process the multiple video and audio signals into a single merged video and audio signal referred to as the data stream. The methods for displaying such video and audio signals may include Composite, S-Video, RGB, HDMI, VGA and multiple integrated connections for built-in displays, such as LCD, LED, and OLED. The data stream is then transmitted to the first communication device, such as the smart phone. The smart phone may transmit the data stream over cellular phone data connections to a web server on the internet where viewers can view the data stream in real time using a web browser or custom application. Again, the web server may act as a content distribution network which may format the data stream into a format that can be viewed by the viewer's viewing device. Any number of real time operating systems may be utilized to transmit the data stream in real time, including but not limited to, Ubuntu, Android, WindowsCE, Windows Mobile and a custom Linux derivative. A second communication device, such as a smart phone or computer, may then be utilized by the viewers to communicate with the user in real time. Thus, the viewers may communicate with the user in real time while the user is recording, playing or streaming the data stream over the internet.

The input/output interface of the image recording device 10 of the present invention could also operate wirelessly through the use of Bluetooth or Wi-Fi technology or other types of wireless transmission technology that may be required for industry or purpose specific reasons, such as using a more secure wireless radio system for law enforcement. The present invention may also utilize more exotic methods or communication such as gravity waves possibly in the form of surface waves or internal waves as well as gravitational radiation as detectable by devices such as the “Weber Bar” or “MiniGrail”. Bluetooth is a proprietary open wireless technology that is standard for exchanging data over short distances using short wavelength radio transmissions from fixed and mobile devices, creating personal area networks (PANs) with high levels of security. The wireless connection could allow the present invention to act as a wireless hands-free headset that could act as stereo headphones and be connected to and communicate with other devices such as computers, cell phones, MP3 players and smart phones via Bluetooth technology. The wireless connection can be used to transmit the real time signal to the first communication device. The wireless connection can be used to stream the real time signal directly to the web server via the internet. The Bluetooth versions of the present invention can communicate with and include: Bluetooth v1.0, v1.0B, v1.1, v1.2, v2.0+EDR, v2.1+EDR, and v3.0+IIS which integrates the Bluetooth module with the 802.11 (Wi-Fi) module for specific tasks. The Bluetooth profiles of the present invention will communicate with SDP, HCI, HID, A2DP, and HSP. It should be noted that Bluetooth and WiFi may both be provided on the same recording device 10.

Although the present invention may use a conventional power source, the present invention may also utilize any combination of alternative energy sources, such as solar cells, thermoelectric generators, magnetic based generators, etc., for primary power, as well as using such energy sources as a secondary power source for charging a conventional battery.

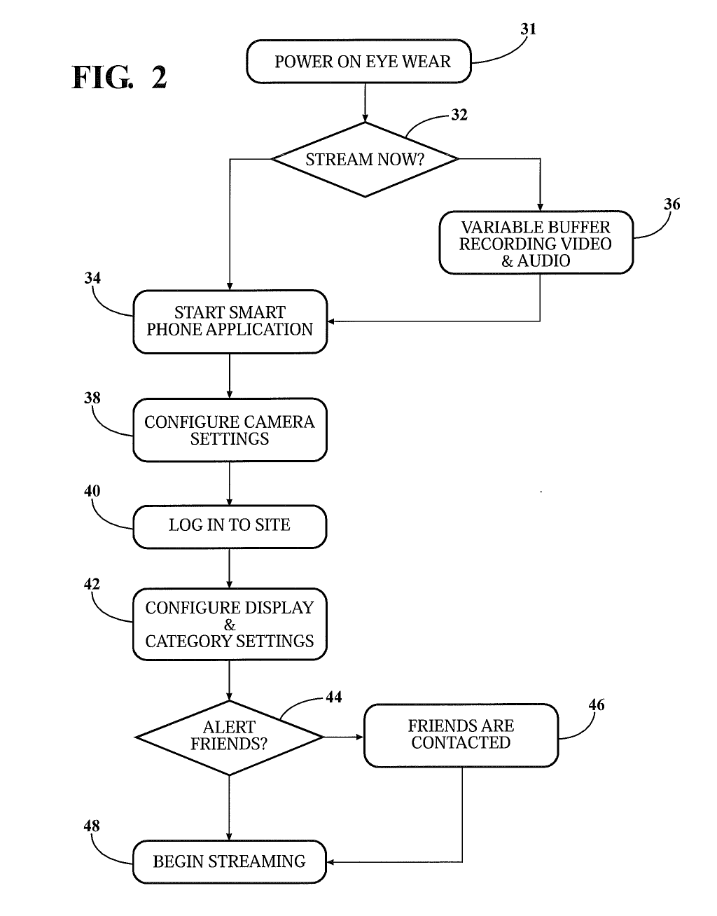

In use, the present invention is utilized by having the user place the mounting structure 14, such as the eyeglasses 16, on the user's head. As seen in the flow chart of FIG. 2, the power switch is turned on to activate operation of the image sensor 12 of the image recording device 10, as stated in block 31. The user can then decide, as stated in decision block 32, whether to stream and/or record and store the data stream live to the first communication device, such as the smart phone, as stated in block 34, or whether to record and store the images on the recording media of the image recording device 10, as stated in block 36. If the user decides to record the images, then the data stream can be sent to the content delivery network via the smart phone, as stated in block 34, at a later time. If the user decides not to stream the data and also not to record, then the device will enter an idle mode where it buffers the data stream. At some later time, the user could decide to begin streaming the buffered data stream; in essence, this allows the viewer to capture an event that has already taken place even though the user was not actively streaming or recording. However, if the user decides to immediately stream the data stream to the smart phone, as seen in block 34, then the settings of the image sensor 12 may be adjusted on the smart phone, as stated in block 38. The smart phone transmits the data stream to at least one web server on the internet. In order for the viewers to view the data stream on the internet, the viewers log onto a predetermined and configured website, as stated in block 40. The data stream may be configured and displayed on the website, and various categories may be accessed by the viewers through the second communication device, such as the smart phone or computer, as stated in block 42. The website may provide a function wherein the user and/or the viewers can notify or alert their friends of the live streaming of the particular data stream, as stated in decision block 44. If the users decide not to notify their friends, then the data stream may be viewed by the viewers, as seen in block 48. If the users decide to alert their friends, then the friends are alerted, as stated in block 46, and all viewers can begin viewing the data stream, as stated in block 48. The viewers may be given the ability to communicate with the user via the second communication device, such as a smart phone or a computer or any other device that is operable to output the data stream in a form that is perceptible to the viewer, so that the viewer can experience the user's environment and the user's relationship to the environment.

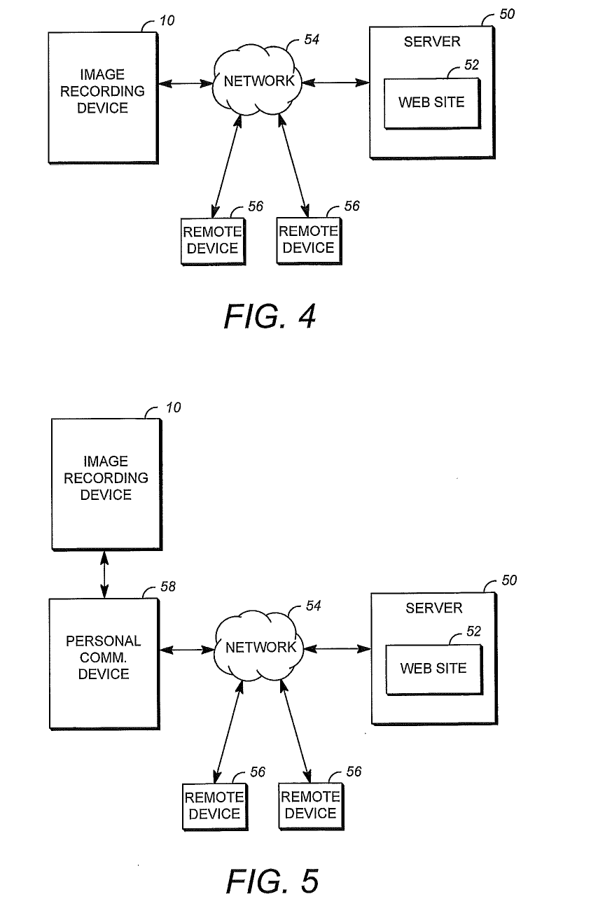

FIG. 4 shows an example of an environment for implementation of a system for streaming and viewing a user's visual and audio experiences, which incorporates the methods and apparatuses described previously. The system can include the image recording device 10 and a server 50 that hosts a website 52. The image recording device 10 can communicate with the server 50 via a network 54. The network 54 can be or include the internet and can also be or include any other type of network operable to transmit signals and/or data. At least one remote device 56 is also in communication with the server 50 via the network. The remote device 56 can be used by a viewer to received and view a real time signal, such as a video stream, from the image recording device 10. It is anticipated that numerous (i.e., thousands) of remote devices could be connected to the server 50. As previously described, the image recording device 10 can create a real time signal including at least one of video footage, still images, audio, and/or metadata that is captured by the image recording device 10. This real time signal is transmitted to the server 50 over the network 54. The server 50 can format the real time signal for transmission via the website 52. A viewer that is using the remote device 56 can connect to the web site 52 that is hosted by the server 50. Using the website 52, the real time signal can be transmitted to the remote device 56 from the server 50.

In the example shown in FIG. 4, the real time signal is transmitted directly from the image recording device 10 to the server 50 via the network 54. In another example, which is shown in FIG. 5, the real time signal can be transmitted to the server 50 from the image recording device indirectly.

As shown in FIG. 5, the image recording device 10 is in communication with a personal communication device 58, such as a smart phone. The communication between image recording device 10 and the personal communication device 58 can be a wireless connection or can be a wired connection using any suitable protocol. As one example, the image recording device can communicate with the personal communication device 58 via a wireless protocol such as Bluetooth. Using such a protocol, the image recording device 10 transmits the real time signal to the personal communications device 58. The personal communication device 58 relays the real time signal that is received from the image recording device 10 to the server 50. Operation of this system is otherwise as described in connection with FIG. 4.

Although described herein as a single server, it should be understood that a web server, such as the server 50, can be implemented in the form of multiple computers, processors, or other systems working in concert.

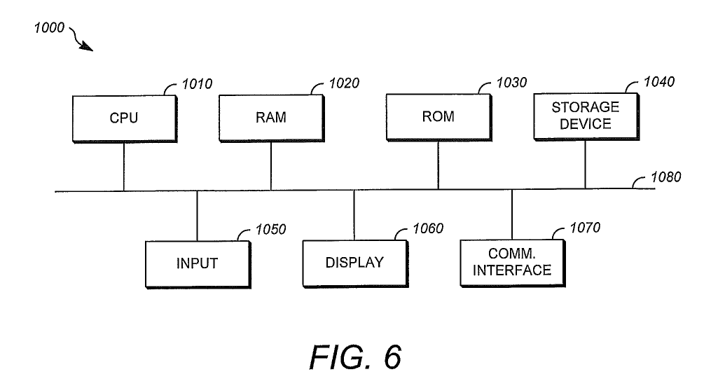

An example of a device that can be used as a basis for implementing the systems and functionality described herein, such as the server 52, the remote devices 56, and the personal computing device 58 is a conventional computing device 1000, as shown in FIG. 6. In addition, a computing device such as the computing device 1000 can be incorporated in the image recording device 10. The conventional computer 1000 can be any suitable conventional computer, such as in the form of a desktop computer, server computer, laptop computer, tablet computer, or smart phone. As an example, the conventional computer 1000 can include a processor such as a central processing unit (CPU) 1010 and memory such as RAM 1020 and ROM 1030. A storage device 1040 can be provided in the form of any suitable computer readable medium, such as a hard disk drive. One or more input devices 1050, such as a keyboard and mouse, a touch screen interface, etc., allow user input to be provided to the CPU 1010. A display 1060, such as a liquid crystal display (LCD) or a cathode-ray tube (CRT), allows output to be presented to the user. The input devices 1050 and the display 1060 can be incorporated in a touch sensitive display screen. A communications interface 1070 is any manner of wired or wireless means of communication that is operable to send and receive data or other signals using the network 108. The CPU 1010, the RAM 1020, the ROM 1030, the storage device 1040, the input devices 1050, the display 1060 and the communications interface 1070 are all connected to one another by a bus 1080.

It is anticipated that various features of the website may allow viewers to interact with the website in various ways. For instance, a crowd source decision making feature may allow viewers to give suggestions to a user's text question, such as “Which way should I go?” The viewers can give individual answers, and the website could determine a mean result which could be published and sent to the user. Other features can provide various alerts to viewers based on certain trigger values the ambient light detects a higher level of light for a high action event, then the viewer could be notified. The alert function can also alert viewers as to certain users streaming data from the image recording device 10. Location based advertising can also be utilized wherein advertisement could be displayed based on the location of the user or items the user may view.

It is also anticipated that the apparatus and method of the present invention can be utilized for numerous applications. For instance, the present invention can be utilized for social networking wherein video footage can be streamed and archived as opposed to posting a few words on a website blog. Other applications include real time shared experiences, such as sharing activities with friends and family in real time. The field of medical triage and assistance could benefit from the present invention, as doctors and nurses could actually see what an EMT or paramedic is experiencing so as to provide sound advice to the EMT or paramedic in extreme medical situations. Surgeons can stream live video from a surgery so that colleagues can watch and comment from off-site. Field reporters can use the present invention to send high quality, high definition video in real time without the need for setting up or utilizing bulky video cameras. Remote skilled workers can benefit by obtaining assistance in the field by sending live streaming video of a specific task or problem that needs to be resolved or corrected. Celebrities can stream their activities in real time for fans to view their experiences. Law enforcement officers can stream live video of dangerous situations for comment or analysis by ranking personnel. The film and movie industry can benefit from the present invention by having live video streamed off-site to a director so that the director can direct and capture video footage. Sporting events and participants can provide live streaming video so that viewers can experience the activities of the sporting event. The retail industry can also benefit by having users provide live streaming video of clothing or other items for purchase so that viewers can comment and provide advice to the user on the purchase of such products. The present invention is not limited to the above applications, but rather, the above-noted applications are but an example of the applications in which the present invention may be utilized.

While the invention has been described in connection with what is presently considered to be the most practical and preferred embodiment, it is to be understood that the invention is not to be limited to the disclosed embodiments, but to the contrary, it is intended to cover various modifications or equivalent arrangements included within the spirit and scope of the appended claims. The scope is to be accorded the broadest interpretation so as to encompass all such modifications and equivalent structures as is permitted under the law.

What is claimed is:

1. A method for streaming and viewing a user's visual and audio experiences, comprising the steps of:
removably mounting an image recording device in close proximity to a user's eyes such that said image recording device is operable to record said user's visual and audio experiences;
creating a real time signal by said image recording device, the real time signal including at least one of video footage, still images, or audio captured by said image recording device;
streaming said real time signal from said image recording device to a server using at least one communications network; and
transmitting said real time signal from the server to a remote communication device for producing an output that is perceptible to a viewer using the remote communication device so that said viewer can experience the user's environment and the user's relationship to the environment.

2. The method as stated in claim 1, wherein removably mounting an image recording device in close proximity to a user's eyes further comprises the steps of:
providing a pair of eyeglasses to be worn on said user's head; and
mounting said image recording device to said eyeglasses.

3. The method as stated in claim 1, wherein the real time signal includes metadata.

4. The method as stated in claim 1, further comprising the steps of:
providing a pair of spaced image sensors at said image recording device so that said image recording device can produce a real time signal for three dimensional viewing of the real time signal.

5. The method as stated in claim 1, further comprising the steps of:
providing a processor at said image recording device for streaming said real time signal from said image recording device directly to said server.

6. The method as stated in claim 1, wherein streaming said real time signal from said image recording device to said server includes wirelessly transmitting said real time signal from said image recording device to a local communication device, and relaying said real time signal from said local communication device to said server.

7. The method as stated in claim 6, wherein said local communication device is a smart phone.

8. The method as stated in claim 1, further comprising the steps of:
providing a content distribution network in communication with said server to format the real time signal such that the real time signal can be viewed by the remote communication device.

9. The method as stated in claim 1, further comprising the steps of:
providing a website at the server for receiving the real time signal and allowing access to the real time signal by the remote communication device.

10. The method as stated in claim 9, further comprising the steps of:
requiring viewers of the website to properly login to the website; and
allowing viewers of the website to select and view the real time signal.

11. The method as stated in claim 10, further comprising the steps of:
allowing viewers of the website to communicate directly with other users streaming the at least one real time signal.

12. The method as stated in claim 10, further comprising the steps of:
allowing viewers of the website to communicate with one another through the website regarding the at least one real time signal.

13. The method as stated in claim 1, further comprising the steps of:
providing the user with the control of if and when to stream the real time signal.

14. The method as stated in claim 1, further comprising the steps of:
the at least one communications network includes the internet.

15. A method for streaming and viewing a user's visual and audio experiences, comprising the steps of:
removably mounting eyeglasses to a user's head wherein an image recording device is mounted to said eyeglasses such that said image recording device is operable to record said user's visual and audio experiences;
creating a real time signal by said imaging recording device, the real time signal including at least one of video footage or still images and/or audio captured by said image recording device;
streaming said real time signal from said image recording device to a first communication device;
receiving and transmitting said real time signal to a webserver wherein said real time signal is sent to a website on the internet; and
transmitting said real time signal on said internet to a second communication device wherein a viewer can view and/or hear said real time signal and communicate with said user in real time.

16. The method as stated in claim 15, further comprising the steps of:
providing a multi core processor mounted in said eyeglasses and acting as said first communication device.

17. The method as stated in claim 15, further comprising the steps of:
providing a smart phone as said first communication device.

18. The method as stated in claim 15, further comprising the steps of:
providing a website at said server for allowing the viewers to view said at least one real time signal;
requiring viewers of the website to properly login to the website;
allowing the viewers of the website to select and view the at least one real time signal;
allowing the viewers of the website to communicate directly with the users streaming the at least one real time signal; and
allowing viewers of the website to communicate with one another through the website regarding the at least one real time signal.

19. The method as stated in claim 15, further comprising the steps of:
providing the user with the control of if and when to stream the real time signal.

20. The method as stated in claim 15, further comprising the steps of:
providing the user with the control of recording the real time signal and/or streaming the record real time signal at a later time.
